(19) United States
(12) Patent Application Publication
(10) Pub. No.: US 2025/0286444 A1
(43) Pub. Date: Sep. 11, 2025

(54) ROTOR

(71) Applicant: TOYOTA JIDOSHA KABUSHIKI KAISHA, Toyota-shi (JP)

(72) Inventor: Motoaki KAMIMURA, Toyota-shi (JP)

(73) Assignee: TOYOTA JIDOSHA KABUSHIKI KAISHA, Toyota-shi (JP)

(21) Appl. No.: 18/968,234

(22) Filed: Dec. 4, 2024

(30) Foreign Application Priority Data
Mar. 5, 2024 (JP) 2024-032984

(51) Int. Cl. H02K 13/00; H02K 1/26; H02K 3/50

(52) U.S. Cl. CPC H02K 13/003; H02K 1/26; H02K 3/50; H02K 2203/09

(57) ABSTRACT

The slip ring structure includes two conductive rings disposed on the outer periphery of the shaft, two busbars each extending from the two conductive rings to electrically connect the two conductive rings to the windings of the plurality of coils, and a resin molded article that holds the two conductive rings and the two busbars by insert molding. The resin molded article has a molded article body holding two conductive rings, an annular terminal holding portion holding the terminal portions of the two busbars, and two connecting portions connecting the molded article body and the terminal holding portion. The terminal holding portion is held by the sealing resin, whereby the slip ring structure is fixed to the shaft.

### CROSS-REFERENCE TO RELATED APPLICATION

This application claims priority to Japanese Patent Application No. 2024-032984 filed on Mar. 5, 2024, incorporated herein by reference in its entirety.

### BACKGROUND

### 1. Technical Field

The present disclosure relates to a rotor.

### 2. Description of Related Art

Japanese Patent No. 5769871 (JP 5769871 B) discloses a technology of reducing cracking in a weld line of a molded article body which holds two rings by insert molding, includes a shaft of a rotor of an rotating electric machine press-fitted, and is made of a resin in a slip ring device included in the rotor.

### SUMMARY

It is known that in the slip ring device in JP 5769871 B, a tightening margin decreases at a high temperature and the tightening margin increases at a low temperature due to a difference in thermal expansion coefficients of a resin and metal.

In JP 5769871 B, the tightening margin at the time of assembly is increased in order to leave a tightening margin even at a high temperature. However, since the tightening margin increases at a low temperature on the contrary, a stress generated in the molded article body increases. Therefore, there is a concern that even if resin cracking during assembly can be prevented, the tightening margin increases and resin cracking occurs at a low temperature according to JP 5769871 B.

Here, there is a trade-off relationship between the fact that the tightening margin remains even at a high temperature and the fact that resin cracking does not occur even in the state where the tightening margin has increased at a low temperature. Therefore, in order to balance them, strict dimensional control of the inner diameter of the molded article body and the outer diameter of the shaft, which is not realistic at all, will be required.

The present disclosure provides a technology of stably fixing a slip ring structure to a shaft.

There is provided a rotor of a rotating electric machine, the rotor including: a core;
a plurality of coils provided in the core;
a sealing resin configured to seal the plurality of coils;
a shaft provided at the core; and
a slip ring structure configured to corotate with the shaft, in which
the slip ring structure includes
two conductive rings disposed on outer periphery of the shaft,
two busbars extending from the two conductive rings, respectively, to electrically connect the two conductive rings to windings of the plurality of coils, and
a resin molded article configured to hold the two conductive rings and the two busbars by insert molding,
the resin molded article includes
a molded article body configured to hold the two conductive rings,
an annular terminal holding portion configured to hold terminal portions of the two busbars, and
at least one connecting portion configured to connect the molded article body and the terminal holding portion, and
the terminal holding portion is held by the sealing resin to fix the slip ring structure to the shaft. According to the above configuration, it is possible to stably fix the slip ring structure to the shaft.

Also, the terminal holding portion may have a tubular holding portion body and a projecting portion projecting radially outward from an outer peripheral surface of the holding portion body, and
the projecting portion may be sealed with the sealing resin.

According to the above configuration, it is possible to stably fix the slip ring structure to the shaft in the axial direction and the circumferential direction of the shaft.

Also, the terminal holding portion may have a holding portion body and a flange projecting radially outward from an outer peripheral surface of the holding portion body, and the flange may be sealed with the sealing resin.

According to the above configuration, it is possible to stably fix the slip ring structure to the shaft in the axial direction of the shaft.

Furthermore, an outer peripheral surface of the terminal holding portion may be formed in an uneven shape when seen from an axial direction of the shaft, and the outer peripheral surface of the terminal holding portion may be sealed with the sealing resin. According to the above configuration, it is possible to stably fix the slip ring structure to the shaft in the circumferential direction of the shaft.

Also, the terminal holding portion may have a holding portion body and a flange projecting radially outward from an outer peripheral surface of the holding portion body, and an outer peripheral surface of the flange may be formed in an uneven shape when seen from an axial direction of the shaft, and the outer peripheral surface of the flange may be sealed with the sealing resin.

According to the above configuration, it is possible to stably fix the slip ring structure to the shaft in the circumferential direction of the shaft.

According to the present disclosure, it is possible to stably fix the slip ring structure to the shaft.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view of a rotor;

FIG. 2 is an exploded perspective view of the rotor;

FIG. 3 is an enlarged view of part A of FIG. 2; and

FIG. 4 is a cross-sectional view of the rotor.

### DETAILED DESCRIPTION OF EMBODIMENTS

Hereinafter, the present disclosure will be described through embodiments of the disclosure, but the disclosure according to the claims is not limited to the following embodiments. Moreover, not all the configurations described in the embodiments are essential as means for solving the problems. For clarity of explanation, the following description and the drawings are omitted and simplified as appropriate. In the drawings, the same elements are denoted by the same reference numerals, and redundant descriptions are omitted, as necessary.

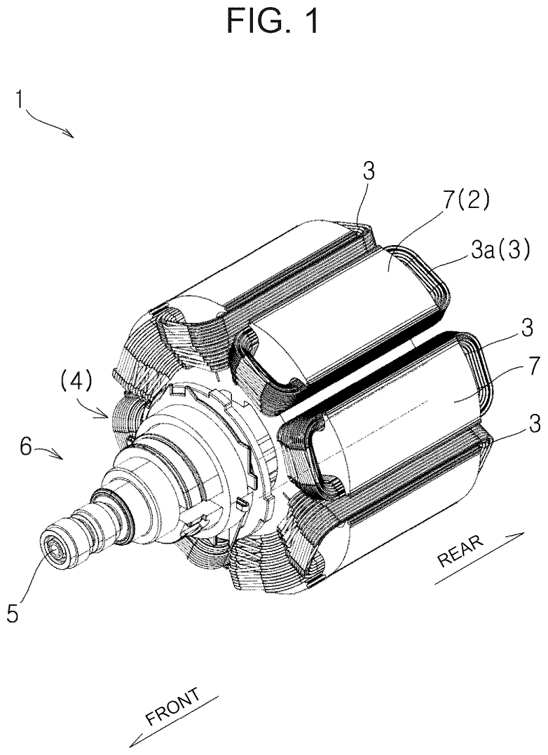

FIG. 1 is a perspective view of a rotor 1. The rotor 1 typically constitutes a motor of the winding field type. The motor includes a stator (not shown) to which an armature current is supplied, and a rotor 1 to which a field current is supplied.

As shown in FIG. 1, the rotor 1 includes a core 2, a plurality of coils 3, a sealing resin 4, a shaft 5, and a slip ring structure 6.

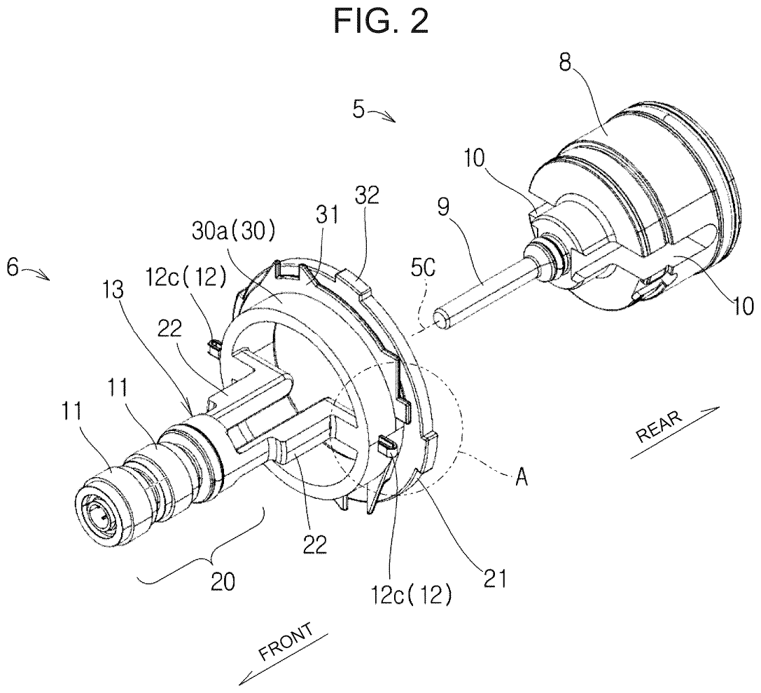

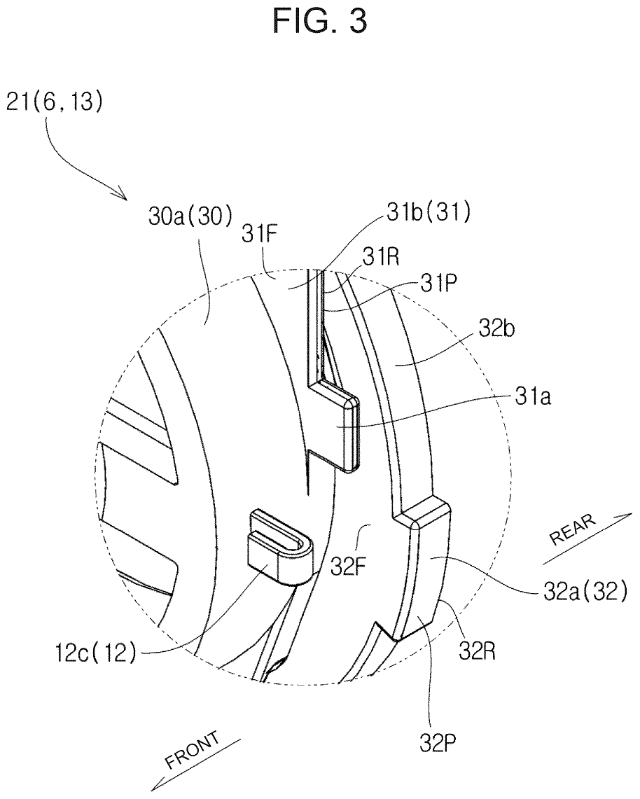

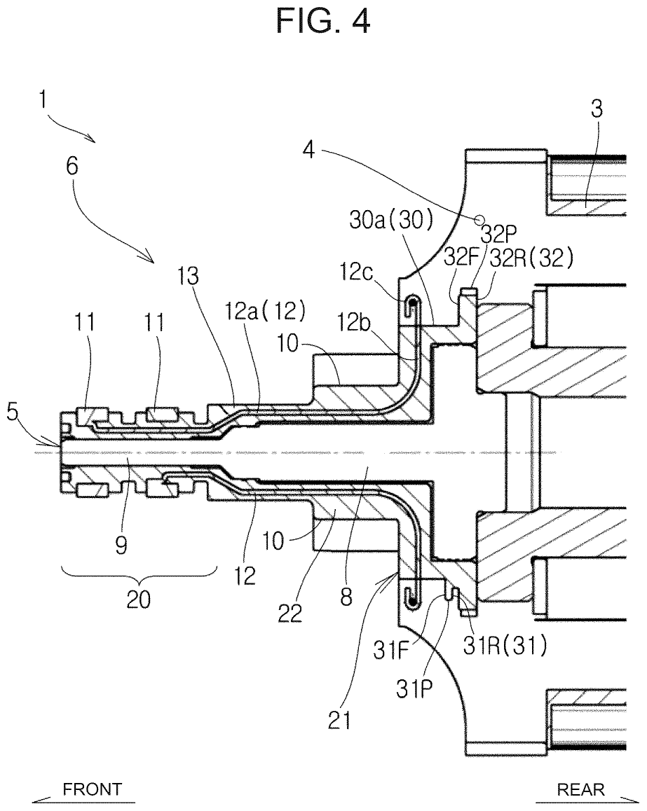

FIG. 2 shows an exploded perspective view of the rotor 1. FIG. 3 shows an enlarged view of part A of FIG. 2. FIG. 4 shows a cross-sectional view of the rotor 1. Note that only the shaft 5 and the slip ring structure 6 are shown in FIG. 2 for convenience of explanation.

Referring to FIG. 1, the core 2 is typically formed by laminating a plurality of electrical steel sheets. The core 2 has a plurality of teeth 7.

The plurality of coils 3 are respectively provided in the plurality of teeth 7 of the core 2. The coils 3 are formed of a winding 3a. The winding 3a is typically a round wire.

As shown in FIG. 4, the sealing resin 4 seals the plurality of coils 3. The sealing resin 4 is typically an epoxy resin. For convenience of explanation, hatching of the sealing resin 4 is omitted in FIG. 4.

Returning to FIG. 1, the core 2 is fixed to the shaft 5. As shown in FIG. 2, the shaft 5 includes a shaft body 8 that penetrates the core 2, and a shaft distal end portion 9 having a diameter smaller than that of the shaft body 8. Two busbar accommodating grooves 10 are formed in the shaft body 8. The two busbar accommodating grooves 10 are formed on opposite sides of the shaft 5 in the central axial 5C.

The slip ring structure 6 is configured to rotate with the shaft 5 while being fixed to the shaft 5. The slip ring structure 6 includes two conductive rings 11, two busbars 12, and a resin molded article 13.

As shown in FIG. 4, the two conductive rings 11 are arranged on the outer periphery of the shaft distal end portion 9 of the shaft 5. The two conductive rings 11 are spaced apart from each other in the axial direction of the shaft 5. The two conductive rings 11 are exposed radially outward. Here, the radially outer side means an outer side of the shaft in the radial direction. Conversely, radially inward means radially inward of the shaft 5.

The two busbars 12 electrically connect the two conductive rings 11 to the winding 3a constituting the plurality of coils 3. Each of the two busbars 12 is electrically connected to two conductive rings 11. Each of the two busbars 12 extends from the two conductive rings 11 along the axial direction of the shaft 5, and then extends radially outward. Therefore, each of the two busbars 12 extends in an approximately L-shape when viewed from a direction orthogonal to the axial direction of the shaft 5. Here, the front and the rear are defined. Both the front and the rear are directions parallel to the axial direction of the shaft 5. The front is the direction in which the two conductive rings 11 are viewed from the plurality of coils 3. The rear side is a direction in which the plurality of coils 3 are viewed from the two conductive rings 11. The busbars 12 each include a front busbar 12a extending rearward from the corresponding conductive ring 11 and a rear busbar 12b extending radially outward from the rear end of the front busbar 12a. A terminal portion 12c to which the winding 3a is crimped or soldered is formed at a distal end of the rear busbar 12b of each of the busbars 12.

Returning to FIG. 2, the resin molded article 13 holds the two conductive rings 11 and the two busbars 12 by insert molding. Specifically, the resin molded article 13 includes a molded article body 20, a terminal holding portion 21, and two connecting portions 22. The molded article body 20, the two connecting portions 22, and the terminal holding portion 21 are arranged in this order toward the rear.

The molded article body 20 has a cylindrical shape and holds two conductive rings 11. The molded article body 20 is lightly press-fitted to the shaft distal end portion 9 of the shaft 5. However, the molded article body 20 may not be press-fitted to the shaft distal end portion 9 of the shaft 5.

The terminal holding portion 21 is annular and holds the terminal portions 12c of the two busbars 12. However, the terminal holding portion 21 may not be annular.

The two connecting portions 22 are formed so as to connect the molded article body 20 and the terminal holding portion 21. The two connecting portions 22 are formed in an L-shape so as to cover the two busbars 12.

Hereinafter, the terminal holding portion 21 will be described in detail with reference to FIGS. 2 to 4.

As illustrated in FIG. 2, the terminal holding portion 21 includes a cylindrical holding portion body 30, an uneven projecting portion 31 protruding radially outward from an outer peripheral surface 30a of the holding portion body 30, and flange 32 protruding radially outward from an outer peripheral surface 30a of the holding portion body 30. The uneven projecting portion 31 is a specific example of a protrusion. However, the holding portion body 30 may not have a cylindrical shape.

The terminal portions 12c of the two busbars 12 are exposed so as to protrude radially outward from the outer peripheral surface 30a of the holding portion body 30.

The uneven projecting portion 31 is disposed rearward of the terminal portions 12c of the two busbars 12. The uneven projecting portion 31 is formed in a thin plate shape orthogonal to the axial direction of the shaft 5. As shown in FIG. 3, the uneven projecting portion 31 includes a first projecting portion 31a and a second projecting portion 31b that differ from the central axial 5C of the shaft 5. In one embodiment, the second projecting portion 31b protrudes radially outward from the first projecting portion 31a. Therefore, it can be said that the uneven projecting portion 31 has an uneven outer peripheral surface 31P when viewed along the axial direction of the shaft 5. The uneven projecting portion 31 has a front surface 31F facing forward and a rear surface 31R facing rearward.

The flange 32 is disposed rearward of the uneven projecting portion 31. The flange 32 is formed in a thin plate shape orthogonal to the axial direction of the shaft 5. The flange 32 includes first flange portions 32a and second flange portions 32b that differ in distance from the central axial 5C of the shaft 5. For example, the first flange portions 32a protrudes radially outward as compared to the second flange portions 32b. Therefore, it can be said that the flange 32 has an uneven outer peripheral surface 32P when viewed along the axial direction of the shaft 5. The flange 32 has a forward facing front surface 32F and a rearward facing rear surface 32R.

As shown in FIG. 4, the terminal holding portion 21 is held by the sealing resin 4. As a result, the slip ring structure 6 is stably fixed to the shaft 5. A specific example is as follows.

The uneven projecting portion 31 is sealed with the sealing resin 4. Specifically, the front surface 31F and the rear surface 31R of the uneven projecting portion 31 are covered with the sealing resin 4. Therefore, movement of the slip ring structure 6 in the front-rear direction with respect to the shaft 5 is restricted, so that the slip ring structure 6 is stably fixed in the front-rear direction by the shaft 5. In addition, the first projecting portion 31a and the second projecting portion 31b of the uneven projecting portion 31 are both sealed with the sealing resin 4, and the outer peripheral surface 31P of the uneven projecting portion 31 is sealed with the sealing resin 4. Therefore, since the rotation of the slip ring structure 6 with respect to the shaft 5 is restricted, the slip ring structure 6 is stably fixed in the circumferential direction by the shaft 5.

The flange 32 is sealed with a sealing resin 4. Specifically, the front surface 32F and the rear surface 32R of the flange 32 are covered with the sealing resin 4. Therefore, movement of the slip ring structure 6 in the front-rear direction with respect to the shaft 5 is restricted, so that the slip ring structure 6 is stably fixed in the front-rear direction by the shaft 5. Further, the first flange portions 32a and the second flange portions 32b of the flange 32 are both sealed by the sealing resin 4, the outer peripheral surface 32P of the flange 32 is sealed by the sealing resin 4. Therefore, since the rotation of the slip ring structure 6 with respect to the shaft 5 is restricted, the slip ring structure 6 is stably fixed in the circumferential direction by the shaft 5.

As described above, the uneven projecting portion 31 and the flange 32 can independently exhibit a function of stably fixing the slip ring structure 6 in the circumferential direction by the shaft 5 and a function of stably fixing the slip ring structure 6 in the axial direction by the shaft 5.

As shown in FIG. 2, the two connecting portions 22 of the slip ring structure 6 are inserted into the two busbar accommodating grooves 10 of the shaft 5, respectively. As a result, the rotation of the slip ring structure 6 with respect to the shaft 5 is also restricted.

Preferred embodiments of the present disclosure have been described above. The above embodiments have the following features.

The rotor 1 includes a core 2, a plurality of coils 3 provided in the core 2, a sealing resin 4 for sealing the plurality of coils 3, a shaft 5 fixed to the core 2, and a slip ring structure 6 provided around the shaft 5. The slip ring structure 6 comprises two conductive rings 11 arranged on the outer circumference of the shaft 5. The slip ring structure 6 comprises two busbars 12 each extending from two conductive rings 11 and a resin molded article 13 holding the two conductive rings 11 and the two busbars 12 by insert molding in order to electrically connect the two conductive rings 11 to the winding 3a of the plurality of coils 3. The resin molded article 13 includes a molded article body 20 that holds the two conductive rings 11, a ring-shaped terminal holding portion 21 that holds the terminal portions 12c of the two busbars 12, and two connecting portions 22 that connect the molded article body 20 and the terminal holding portion 21. The terminal holding portion 21 is held by the sealing resin 4, and thereby the slip ring structure 6 is fixed to the shaft 5. According to the above configuration, the slip ring structure 6 can be stably fixed to the shaft 5 without depending on the interference between the molded article body 20 and the shaft distal end portion 9 of the shaft 5.

In the above-described embodiment, the resin molded article 13 has two connecting portions 22. However, instead of this, the resin molded article 13 may have only one connecting portion 22, or may have three or more connecting portions 22.

Further, the terminal holding portion 21 includes a cylindrical holding portion body 30 and an uneven projecting portion 31 (protruding portion) protruding radially outward from an outer peripheral surface 30a of the holding portion body 30. The uneven projecting portion 31 is sealed with the sealing resin 4. According to the above configuration, the slip ring structure 6 can be stably fixed to the shaft 5 in the axial direction and the circumferential direction of the shaft 5.

The terminal holding portion 21 includes a cylindrical holding portion body 30 and a flange 32 protruding radially outward from an outer peripheral surface 30a of the holding portion body 30. The flange 32 is sealed with a sealing resin 4. According to the above configuration, the slip ring structure 6 can be stably fixed to the shaft 5 in the axial direction of the shaft 5.

Further, when viewed from the axial direction of the shaft 5, the outer peripheral surface 31P of the uneven projecting portion 31 of the terminal holding portion 21 is formed in an uneven shape, and the outer peripheral surface 31P of the uneven projecting portion 31 of the terminal holding portion 21 is sealed with the sealing resin 4. According to the above configuration, the slip ring structure 6 can be stably fixed to the shaft 5 in the circumferential direction of the shaft 5. The outer peripheral surface 31P of the uneven projecting portion 31 constitutes a part of the outer peripheral surface of the terminal holding portion 21.

The terminal holding portion 21 includes a cylindrical holding portion body 30 and a flange 32 protruding radially outward from an outer peripheral surface 30a of the holding portion body 30. The outer peripheral surface 32P of the flange 32 is formed in an uneven shape when viewed from the axial direction of the shaft 5, and the outer peripheral surface 32P of the flange 32 is sealed with the sealing resin 4. According to the above configuration, the slip ring structure 6 can be stably fixed to the shaft 5 in the circumferential direction of the shaft 5.

What is claimed is:

1. A rotor of rotating electric machine, the rotor comprising:
a core;
a plurality of coils provided in the core;
a sealing resin configured to seal the plurality of coils;
a shaft provided at the core; and
a slip ring structure configured to corotate with the shaft, wherein
the slip ring structure includes
two conductive rings disposed on outer periphery of the shaft,
two busbars extending from the two conductive rings, respectively, to electrically connect the two conductive rings to windings of the plurality of coils, and
a resin molded article configured to hold the two conductive rings and the two busbars by insert molding,
the resin molded article includes
a molded article body configured to hold the two conductive rings,
an annular terminal holding portion configured to hold terminal portions of the two busbars, and
at least one connecting portion configured to connect the molded article body and the terminal holding portion, and
the terminal holding portion is held by the sealing resin to fix the slip ring structure to the shaft.

2. The rotor according to claim 1, wherein:
the terminal holding portion has a tubular holding portion body and a projecting portion projecting radially outward from an outer peripheral surface of the holding portion body; and
the projecting portion is sealed with the sealing resin.

3. The rotor according to claim 1, wherein:
the terminal holding portion has a holding portion body and a flange projecting radially outward from an outer peripheral surface of the holding portion body; and
the flange is sealed with the sealing resin.

4. The rotor according to claim 1, wherein:
an outer peripheral surface of the terminal holding portion is formed in an uneven shape when seen from an axial direction of the shaft; and
the outer peripheral surface of the terminal holding portion is sealed with the sealing resin.

5. The rotor according to claim 1, wherein:
the terminal holding portion has a holding portion body and a flange projecting radially outward from an outer peripheral surface of the holding portion body; and
an outer peripheral surface of the flange is formed in an uneven shape when seen from an axial direction of the shaft, and the outer peripheral surface of the flange is sealed with the sealing resin.
